(19) United States
(12) Patent Application Publication
(10) Pub. No.: US 2024/0211644 A1
(43) Pub. Date: Jun. 27, 2024

(54) METHODS AND SYSTEMS FOR CREATING SITE DRAWINGS

(71) Applicant: RAKUTEN SYMPHONY SINGAPORE PTE. LTD., Singapore (SG)

(72) Inventors: Dheer PRATAP, Indore (IN); Anurag SHRIVASTAVA, Indore (IN); Yamini JAIN, Indore (IN)

(73) Assignee: RAKUTEN SYMPHONY SINGAPORE PTE. LTD., Singapore (SG)

(21) Appl. No.: 17/801,836

(22) PCT Filed: May 13, 2022
(86) PCT No.: PCT/US2022/029170

§ 371 Date: Nov. 16, 2023

(51) Int. Cl. G06F 30/13

(52) U.S. Cl. CPC G06F 30/13

(57) ABSTRACT

This disclosure provides methods, apparatuses, and computer-readable mediums for creating or editing a site drawing. In an aspect, a method comprises displaying, on a display of a device, a user interface configured for one or more of creating, accessing, and editing Site Details for a Site; receiving a selection from a user for one from among an elevation and a floor plan; displaying a canvas and one or more components on the user interface; receiving one or more inputs from the user corresponding to the addition of one or more components to the canvas at one or more coordinates; and storing the one or more components and their coordinates in JavaScript Object Notation (JSON).

### TECHNICAL FIELD

The present disclosure relates to methods and systems for creating site drawings.

### BACKGROUND

Computer-aided design (CAD) technology has been implemented to replace manual drafting of architectural drawings with computerized processes. However, CAD programs have been notoriously difficult for an inexperienced user to operate and have not been deployed efficiently in a mobile computing environment.

Further, related art methods and systems for drawing a layout plan for a telecommunications site (e.g., a location where telecommunication equipment is to be potentially installed) require external tools with high cost and particular expertise to use. Moreover, telecommunications-related shapes, objects, and symbols are not available in the related art applications and tools.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for annotation of images in a mobile application are provided by the present disclosure.

Aspects of one or more embodiments allow a user to easily and conveniently create elevation or floor plans and represent different network elements and their positioning in the elevation or floor plans without using third party applications.

Aspects of one or more embodiments allow users to utilize a prior drawing image, a camera-captured image, or a satellite view image to create an elevation or floor plan and append representations of different network elements thereto.

According to embodiments, a method of providing a site drawing includes: displaying, on a display of a device, a user interface configured for one or more of creating, accessing, and editing Site Details for a Site; receiving a selection from a user for one from among an elevation and a floor plan; displaying a canvas and one or more components on the user interface; receiving one or more inputs from the user corresponding to the addition of one or more components to the canvas at one or more coordinates; and storing the one or more components and their coordinates in JavaScript Object Notation (JSON).

According to embodiments, an apparatus for providing a site drawing includes: a memory storage storing computer-executable instructions; and a processor communicatively coupled to the memory storage, wherein the processor is configured to execute the computer-executable instructions and cause the apparatus to: display a user interface configured for one or more of creating, accessing, and editing Site Details for a Site; receive a selection from a user for one from among an elevation and a floor plan; display a canvas and one or more components on the user interface; receive one or more inputs from the user corresponding to the addition of one or more components to the canvas at one or more coordinates; and store the one or more components and their coordinates in JavaScript Object Notation (JSON).

According to embodiments, a non-transitory computer-readable medium contains instructions, which when executed by one or more processors cause an apparatus to: provide a user interface to a user configured for one or more of creating, accessing, and editing Site Details for a Site; receive a selection from a user for one from among an elevation and a floor plan; display a canvas and one or more components on the user interface; receive one or more inputs from the user corresponding to the addition of one or more components to the canvas at one or more coordinates; and store the one or more components and their coordinates in JavaScript Object Notation (JSON).

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example device useful for creating site drawings in accordance with embodiments of the present invention;

FIG. 2 is an example flow diagram for creating site drawings using JSON in accordance with embodiments of the present invention;

FIG. 3 illustrates a user interface displaying Site Details;

FIG. 4 illustrates a user interface soliciting the selection of an installation pattern;

FIG. 5 illustrates a user interface soliciting the selection of an elevation or a floor plan;

FIG. 6 illustrates a user interface for applying a texture to a surface in an elevation;

FIG. 7A illustrates a floor plan created by an exemplary user in accordance with embodiments of the present invention;

FIG. 7B illustrates an example screen through one parameters of a telecommunications equipment selectable to be added to a canvas are input; and

FIG. 8 illustrates an exemplary device useful for implementing image annotation in accordance with embodiments of the present invention.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In a related art, a user seeking to create a layout drawing with elevation (side view) and/or floor plan (top view) must use external, costly tools that are not tailored for telecommunication sites. To run effectively, hardware is often needed which is exceptional and difficult to acquire. On the other hand, example embodiments of the present disclosure offer a user-friendly solution which can be implemented on a typical mobile device such as a tablet or smartphone. No particular training is needed to effectively operate a device implementing example embodiments.

Example embodiments also introduce functionality not seen in related art CAD programs. For example, a user can, in a mobile application, select a texture to be applied to a surface in a three-dimensional representation from an internet image associated with the geographic area of the representation, an image stored on the device, and an image captured by an optical device at the command of a user and store the texture using JavaScript Object Notation (JSON). According to the methods and systems of example embodiments, site plans can be stored and saved in JSON format for later output of a bitmap. Using JSON results in a substantially improved user experience during computer-aided design of site plans with less latency and fewer technical glitches.

Advantageously, the embodiments described below provide for using JSON to achieve one or more tasks. In addition, the present disclosure may provide an experience which is pleasing to the user and easily operable for the creation and modification of site plans. In addition, quickly changing requirements may be met and site plans may be deployed in a manner that may minimize waiting time, resulting in an improved user experience. Furthermore, the use of JSON for drawing site plans may yield execution times that may be faster when compared to other related art CAD methodologies.

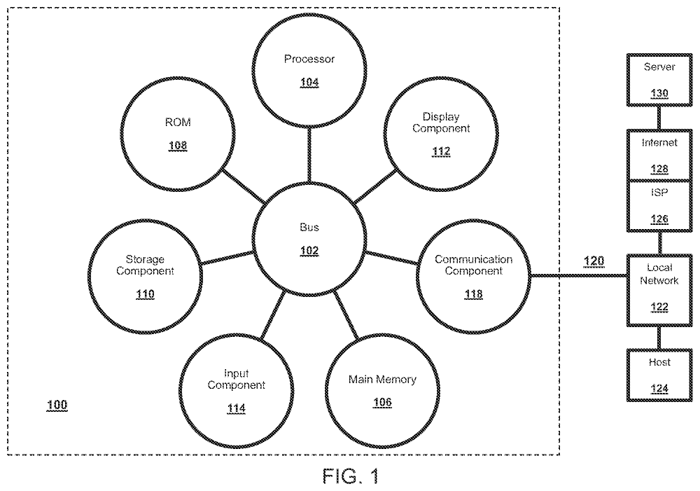

FIG. 1 illustrates a device on which embodiments can be implemented. Device 100 includes a bus 102 or other communication mechanism for communicating information, and microprocessor 104 coupled with bus 102 for processing information.

Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Such instructions, when stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, which can include alphanumeric and other keys, is coupled to bus 102 for communicating information and command selections to processor 104. Another type of user input device is used for cursor control such as a mouse, a trackball, or cursor direction keys for communicating direction information and command selections. Processor 104 can receive signals from input device 114 for controlling cursor movement and calculate associated changes to display 112. A cursor control input device typically has two degrees of freedom in two axes, a first axis (e.g., x) and a second axis (e.g., y), that allows the device to specify positions in a plane.

Computer system 100 may implement the techniques described herein using customized hard-wired logic, one or more ASICs or FPGAs, firmware and/or program logic which in combination with the computer system causes or programs computer system 100 to be a special-purpose machine. According to at least one embodiment, the techniques herein are performed by computer system 100 in response to processor 104 executing one or more sequences of one or more instructions contained in main memory 106. Such instructions may be read into main memory 106 from another storage medium, such as storage device 110. Execution of the sequences of instructions contained in main memory 106 causes processor 104 to perform the process operations described herein.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card, cable modem, satellite modem, or a modem to provide a data communication connection to a corresponding type of telephone line. As another example, communication interface 118 may be a local area network (LAN) card to provide a data communication connection to a compatible LAN. Wireless links may also be implemented. In at least one such implementation, communication interface 118 sends and receives one or more of electrical, electromagnetic and optical signals (as with all uses of “one or more” herein implicitly including any combination of one or more of these) that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are example forms of transmission media.

Computer system 100 can send messages and receive data, including program code, through the network(s), network link 120 and communication interface 118. In at least one embodiment of the Internet example, a server 130 might transmit a requested code for an application program through Internet 128, ISP 126, local network 122 and communication interface 118.

In embodiments, the received code may be one or more of executed by processor 104 as it is received, and/or stored in storage device 110, or other non-volatile storage for later execution.

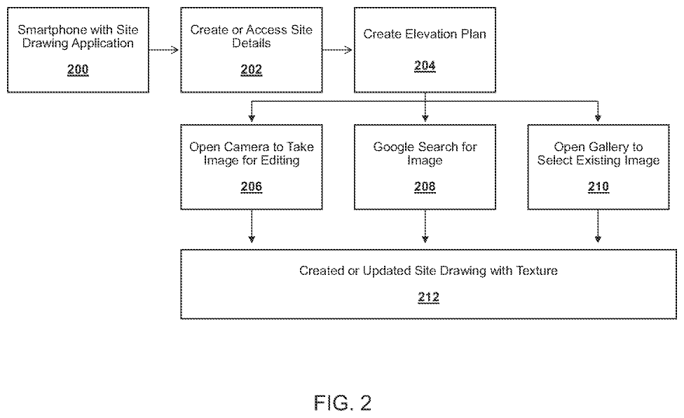

FIG. 2 is an example flow diagram for image annotation using JSON in accordance with embodiments of the present invention.

At Block 200 of FIG. 2, a user initiates a smart phone with a site drawing application. As these drawings are provided as example embodiments solely for the purposes of explanation, the disclosure is not so limited to a smart phone and a whole range of devices can be used to implement embodiments. In some embodiments, the application could operate on a laptop, tablet, or desktop computer. An application as found in an example embodiment could be loaded on to the device such a smart phone in a number of fashions. Using Local network 122 and Internet 128 of FIG. 1, electrical, electromagnetic or optical signals can carry digital data streams encoding an application for use in embodiments. Using input device 114 of FIG. 1, where input device 114 is for example a CD-ROM or DVD-ROM drive, a non-transitory computer-readable medium can be read which contains instructions for an application useful in an example embodiment.

At Block 202 of FIG. 2, Site Details are created or accessed. Site Details comprise relevant information about a particular structure such as identifiers assigned by an organization for ease of reference and the street address of a Site. By an application configured for embodiments, a user can input (i.e., if input device 114 is a keyboard, then the user can typewrite text into fields) data comprising Site Details. Site Details may also be stored in an external database accessible through internet 128 or storage component 110. Via various programming techniques, Site Details can be populated from an external database. Thus in some embodiments, a user can access pre-stored Site Details rather than having to enter them.

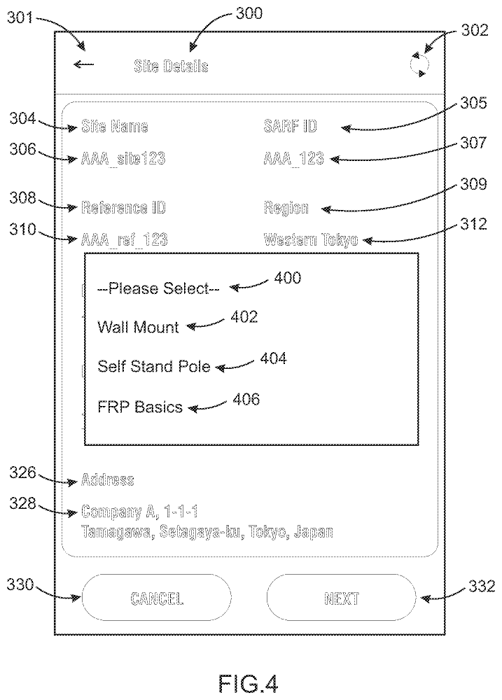

At Block 204 of FIG. 2, a user decides to create an elevation plan (though alternatively, the user may choose to create a floor plan). As described with reference to FIG. 4, a user can choose between a floor plan and an elevation. An elevation is a side view of a Site and can be used to convey three-dimensional information. An elevation sketch is an orthographic projection-a two-dimensional representation of a three-dimensional space. A two-dimensional representation of a three-dimensional object can have a surface known as a texture. Textures are simply images used to skin 3D objects. Any image such as one found in a JPEG file could serve as a texture. For instance, a photo of a brick wall could be used for the two-dimensional appearance of the brick wall. Textures can also be created computationally according to supplied parameters or made by an artist in a program like GIMP or Photoshop.

The elevation plan is shown on a canvas element rendered on a user interface (UI) (e.g., display 114 of exemplary device 100 in FIG. 1). Rendering the UI view may be partitioned into one or more pages and each page may be partitioned into one or more sections. In such an example, the layout information may indicate which resources correspond to each page and/or section of the UI view. In some embodiments, if or when the UI view is rendered (e.g., executed), the UI view may display one page at a time and may provide navigational buttons to move between the pages. In other embodiments, if or when the UI view is rendered, the UI view may display two or more pages simultaneously. Alternatively or additionally, sections of the UI view may be arranged horizontally, vertically, and/or in an overlapped manner. In other optional or additional embodiments, one or more sections of the UI view may be conditionally displayed. That is, a section of the UI view may be shown and/or hidden based on a condition being met (e.g., a particular field and/or parameter is set to a particular value). Alternatively or additionally, a section of the UI may be enabled (e.g., input may be permitted) and/or disabled (e.g., input may not be permitted) based on a condition being met. The disclosure is not limited in this regard.

Once the elevation plan appears on the canvas of the UI, positioning information and/or vertical positioning information for elements (i.e., text and graphics) in a UI differs between embodiments. The positioning information may be indicated relative to a predetermined point (e.g., origin) of the UI view, of a section of the UI view, and/or a page of the UI view, such as, but not limited to, a top-left corner, a center point, or a bottom-right corner. Alternatively or additionally, layout information may comprise layering information (e.g., z-order). In other embodiments, the horizontal positioning and/or vertical positioning may be determined based on automated scripts which dynamically update. For example, an element may be displayed on a top of a UI, and a second element may be displayed on bottom of a UI. In another example, the first element may be displayed on a righthand side of a UI view, and the second element may be displayed to the lefthand side.

Blocks 206-210 provide capabilities for a user to select an image for use in the elevation plan created at Block 204. For the two-dimensional representations in the elevation plan of the three-dimensional Site, a user can select a texture to be applied for each section of each two-dimensional representation. Images to be used in a two-dimensional display can be selected using at least the three protocols described in Blocks 206-210, but these methods are non-exclusive. Images could also be selected in any number of other ways, including through signals received from the internet of things (IOT), augmented reality (AR—an interactive experience of a real-world environment where the objects that reside in the real world are integrated into a computerized environment), artificial intelligence (AI) or virtual reality (VR).

At Block 206 of FIG. 2, a camera application is opened by a user to take an image for editing for use in an elevation plan in an embodiment. A camera application may be a stock camera app that comes pre-installed on a user's phone for example, or a user may also choose from a variety of camera applications offered by third-party providers or even created by the user or the user's organization. Using existing camera applications or building camera applications can both be options for a user in taking an image for editing in embodiments. Developers may provide a camera user interface that is customized to the look of the application or provides special features. Writing code for a purpose-built picture-taking application can provide a more compelling experience for users.

At Block 208 of FIG. 2, a user can choose to conduct a Google search for an image. Other search engines or web-based cloud services could also be used to search for an image. Parameters for the Google search can be received via the input device e.g., input device 114 in the exemplary device of FIG. 1. After receiving a number of results of the Google search, the user can select an image for use in an embodiment from one of the results of the Google search. The user might also find all of the results unsatisfactory and instead proceed with the steps to obtain an image explained at Block 206 and/or Block 210.

At Block 210 of FIG. 2, a user can open a gallery application to select an image stored at a previous time. As with the camera application described in Block 206, the gallery application may be a stock gallery application or it could be a third-party application or it could be programmed and purpose-built for use in an embodiment. The gallery application could comprise only images stored on the local memory of the device being used in the embodiment, or the gallery application could also comprise images accessible to members of a particular organization via network storage drives or other means.

At Block 212 of FIG. 2, a Site Drawing is created or updated comprising the elevation plan and the two-dimensional texture selected at Blocks 206-210. A user may save the created or updated Site Drawing, or the application for use in this exemplary embodiment may be programmed to automatically save. Save is writing data to a storage medium, such as a floppy disk, CD-R, USB flash drive, or hard drive. The save option is found in almost all programs commonly under the “File” drop-down menu or through an icon that resembles a floppy diskette. When clicking the Save option, the file is saved as its previous name. However, if the file is new, the program asks the user to name the file and where to save the file. Unless the program the user is using automatically saves as the user are working, if a file is not saved it is lost. For example, if the computer loses power, or the computer must be rebooted, the work is lost. While the user is working, data is saved in RAM, which is a fast, volatile memory device. It is called “volatile” because RAM loses its data when its power source is lost or turned off. In contrast, storage medium or disk is “non-volatile” storage, because it retains its data even when powered off. Thus, before the user's action at Block 212 of FIG. 2, the created or updated Site Plan is stored in RAM but is not durably stored for future retrieval. Also, at Block 212 of FIG. 2, an updated image is shown on the user interface comprising the elevation plan and the two-dimensional texture as selected and positioned by the user. After this operation the user may continue to perform the operations described in FIG. 2 with additional Sites, returning to Block 200, or may continue working with the existing elevation plan, for example selecting additional images as in Blocks 206-210. The user may also proceed to create a bitmap file encoding (in, for example, file formats including but not limited to .jpg, .tiff, .gif, .svg, .svgz, bmp, .png, and .tif) the updated image shown on the user interface, and may print to paper or transmit a bitmap over the internet.

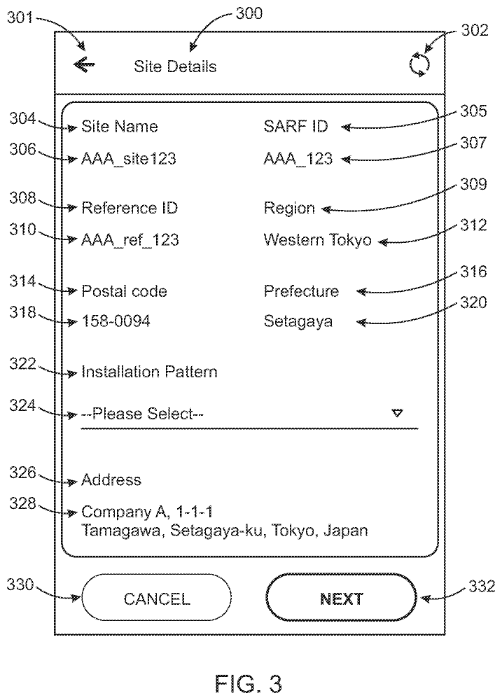

FIG. 3 illustrates a user interface displaying Site Details. This user interface view is shown to a user upon initializing the application useful for implementing this example embodiment.

Site Details 300 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Back button 301 allows the user to trigger a command to exit the user interface and return to a previously displayed and/or default user interface view. In various embodiments back button 301 can return to a user interface view of the application being used for Site Drawings or it can return to a user interface view of an operating system of the device on which the embodiment is being implemented.

Reload button 302 allows a user to update other data fields based on a user's input in one data field. For example, if a user enters a SARF ID and then clicks the reload button, then Site Name, Reference ID, etc. can be retrieved from a database.

Site name title 304 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

SARF ID title 305 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Site name data 306 is a data field which comprises a name for the Site. A user may be able to enter i.e., type a name in the data field or the name can be retrieved from a database.

SARF ID data 307 is a data field which comprises an alphanumeric identifier for the Site. A user may be able to enter i.e., type a SARF ID in the data field or the SARF ID can be retrieved from a database.

Reference ID title 308 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Region title 309 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Reference ID data 310 is a data field which comprises an alphanumeric identifier for the Site. A user may be able to enter i.e., type a Reference ID in the data field or the Reference ID can be retrieved from a database.

Region data 312 is a data field that is designed to contain a region. A region may be defined by an organization for example. A user may be able to enter i.e., type a name in the data field or the name can be retrieved from a database.

Postal code title 314 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Prefecture title 316 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Postal code data 318 is a data field that is designed to contain a Postal code. A Postal code may be defined by a national mail service provider for example. A user may be able to enter i.e., type a Postal code in the data field or the Postal code can be retrieved from a database or via the internet e.g. the website of the national mail service provider.

Prefecture data 320 is a data field that is designed to contain a Prefecture name. A Prefecture may be a subnational governmental subdivision for example. A user may be able to enter i.e., type a Prefecture in the data field or the Prefecture can be retrieved from a database or via the internet e.g. a website.

Installation pattern title 322 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Installation pattern selection 324 offers a user an indication where a user may click. When the user clicks where indicated, an area is indicated as shown in FIG. 4 by which a user may select from several installation pattern options.

Address title 326 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Address data 328 is a data field that is designed to contain an address. An address may be defined by a national mail service provider for example. A user may be able to enter i.e., type an address in the data field or the address can be retrieved from a database.

Cancel button 330 allows a user to exit out of the user interface view shown in FIG. 3 without necessarily entering e.g., the installation pattern. A user's instantiation of Cancel button 330 will return the user to a user interface view of an introductory screen of an application for use in embodiments or to a user interface view of the home screen of a mobile device for example.

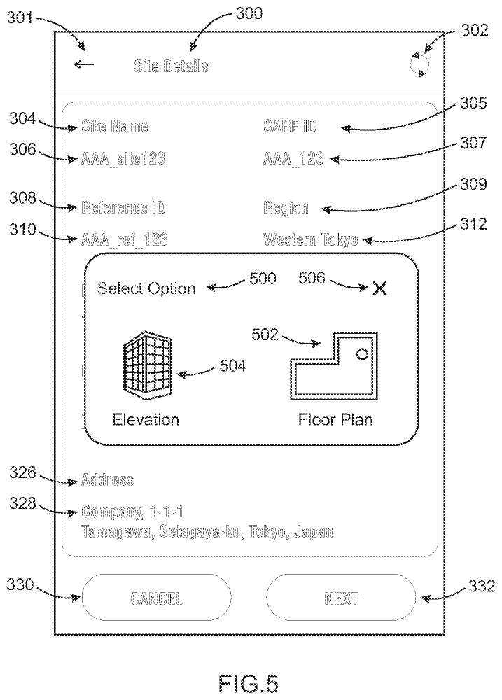

Next button 332 allows the user to navigate forward to the next user interface view in the sequence, i.e., FIG. 5. It can be programmed so that, before next button 332 can trigger a command to advance the user interface view, inputs must be made by a user as shown in FIG. 4 i.e., an installation pattern must be selected. Depending on the programming of the embodiment, a user may also be required to enter data in some or all of the other fields (e.g., Site address) before the Next button is activated.

FIG. 4 illustrates a user interface soliciting the selection of an installation pattern.

In this exemplary embodiment, each of Site Details 300, Back button 301, Reload button 302, Site name title 304, SARF ID title 305, Site name data 306, SARF ID data 307, Reference ID title 308, Region title 309, Address title 326, Address data 328, Cancel button 330 and Next button 332 are visible in the user interface view of FIG. 4. Though visible, they do not have the functionality described in FIG. 3 and do not allow the user to interact with them in any fashion until an installation pattern is selected and a different user interface view is instantiated.

Selection prompt 400 is designed to solicit a user's input on the installation pattern for telecommunications equipment. If a user clicks on the selection prompt itself, a user might be returned to the user interface view of FIG. 3 without the selection of an installation pattern being recorded.

Wall mount 402 represents one option for an installation pattern which can be selected by a user. Applications according to embodiments can trigger other commands and changes in user interfaces to be displayed based on the installation pattern selected. For instance, in the floor plans and elevations creatable by the present disclosure, certain elements can be displayed and populated, such as a wall mount symbol if a user selects Wall mount 402 for an installation pattern.

Self stand pole 404 represents a second option for an installation pattern which can be selected by a user. A self-stand pole for instance may indicate that telecommunications equipment is to be affixed to a pole provided by the service provider.

FRP basics 406 represents a third option for an installation pattern which can be selected by a user. FRP refers to fiber-reinforced plastic which is a material useful in the telecommunications industry.

Other embodiments may offer additional and/or different installation patterns available for selection by a user. Installation patterns could be further divided and described in terms of materials used, shapes and sizes. There are many possible installation and service patterns which can be deployed, and a user could be given a scroll bar to view a range where the number of options for installation patterns exceeds the space in a given window.

FIG. 5 illustrates a user interface soliciting the selection of an elevation or a floor plan. The selection can occur through an input device by input from a user, e.g., input device 114 of FIG. 1.

In FIG. 5, each of Site Details 300, Back button 301, Reload button 302, Site name title 304, SARF ID title 305, Site name data 306, SARF ID data 307, Reference ID title 308, Region title 309, Address title 326, Address data 328, Cancel button 330 and Next button 332 are visible in the user interface view. Though visible, they do not have the functionality described in FIG. 3 and do not allow the user to interact with them in any fashion until an elevation or floor plan is selected and a different user interface view is instantiated.

Select Option title 500 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Cancel button 506 is shown graphically as an X in the user interface view of FIG. 5 and allows a user to exit out of the user interface view shown in FIG. 5 without necessarily making a selection. A user's instantiation of Cancel button 506 will return the user to a previous user interface view (i.e., FIG. 3), a user interface view of an introductory screen of an application for use in embodiments or to a user interface view of the home screen of a mobile device for example.

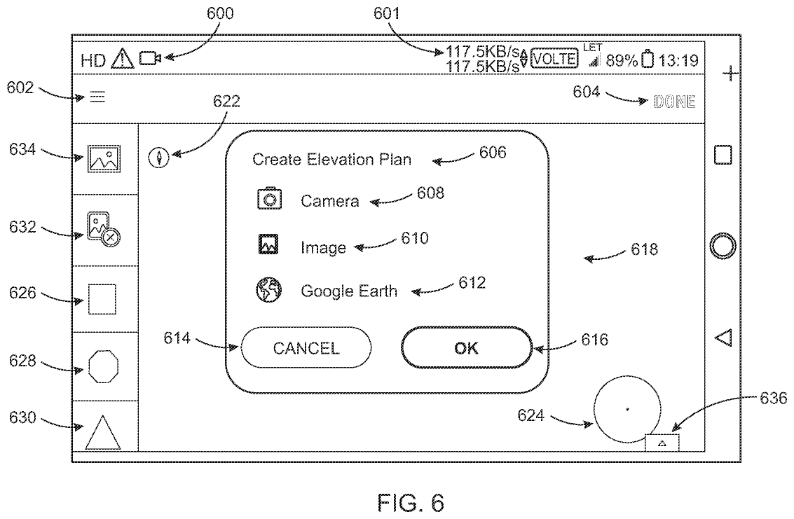

Elevation text and icon 504 triggers the creation of an elevation i.e., the user interface view of FIG. 6. Elevation text and icon 504 is designed to give the user a visual representation of a three-dimensional model of a building to aid the user's understanding of the user interface to be triggered by clicking on elevation text and icon 504. As more fully described below, the user interface view of FIG. 6 is customized for the purpose of creating an elevation and allows for a variety of functions for that purpose.

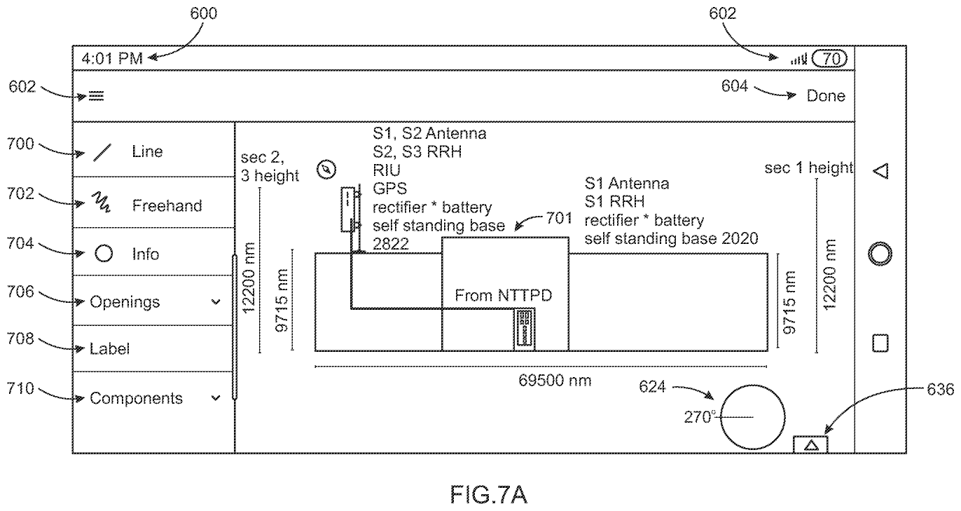

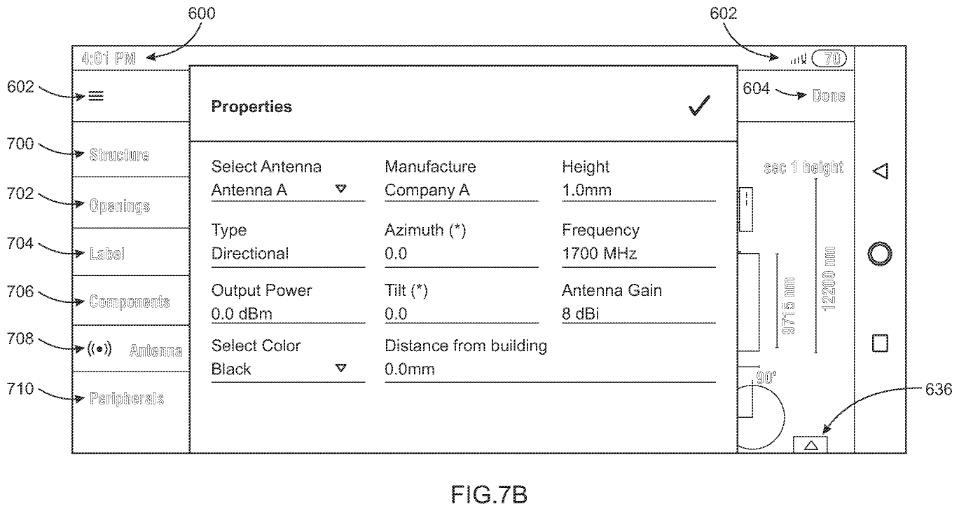

Floor plan 506 triggers the creation of a floor plan i.e., the user interface view of FIG. 7A. Elevation text and icon 504 is designed to give the user a visual representation of a three-dimensional model of a building to aid the user's understanding of the user interface to be triggered by clicking on elevation text and icon 504. As more fully described below, the user interface view of FIG. 6 is customized for the purpose of creating an elevation and allows for a variety of functions for that purpose.

FIG. 6 illustrates a user interface for applying a texture to a surface in an elevation.

Left status indicator bar 600 displays parameters related to the operating conditions of the device. Right status indicator bar 601 displays parameters related to the operating conditions of the device and its communications network service. More and/or different indicators could be displayed at other times or in other embodiments.

Command button 602 triggers one or more preset options to be presented to a user. Upon selection by a user, a further action is performed on the user interface.

Done button 604 allows a user to save the elevation and exit the user interface view. The elevation is saved in JSON and can be output in a bitmap format if the user desires.

Create elevation plan title 606 is text displayed as a title for this user interface view. This text cannot be modified by the user, clicked on or otherwise used to trigger execution of commands. Other embodiments will use a different title, and in embodiments a user may be able to alter the title, or the title could change dynamically based on preset parameters.

Camera icon and text 608 opens a camera application to take an image for editing for use in an elevation plan in an embodiment. A user might take a photo for example of an area of building's wall and an exemplary embodiment of the present disclosure would allow the user to use the photo as a texture on a surface of a three-dimensional model of the building displayed on a user interface.

Image icon and text 610 allows a user to open a gallery application to select an image stored at a previous time. Using the drawing tools found in embodiments, a user can draw structural elements with a particular image captured at a previous time in mind, then use the image or portions of it for textures for the surfaces of the structural elements.

Google Earth icon and text 612 allows a user to conduct a Google search for an image. In an exemplary embodiment a user can look at a portion of a building and visually select the corresponding image in the Google Earth or a similar application. The URL of the Google Earth image or a file path for it can be stored in JSON and used as a texture on a three-dimensional model of the building displayed in the Google Earth image.

Cancel button 614 allows a user to exit out of the user interface view shown in FIG. 6 without creating an image. A user's instantiation of Cancel button 614 will return the user to an introductory screen of the application or to a user interface view of the home screen of a mobile device for use in embodiments.

OK button 616 will return the user to a user interface view like that of FIG. 6 but without elements 606-616. If the user desires to draw an elevation rather than adding an image, OK button 616 provides the user with a quick way of doing so.

Canvas element 618 consists of a drawable region defined in code with height and width attributes. JavaScript code may access a canvas and perform drawing functions (other 2D and 3D APIs may also be utilized). Images are added to canvas element 618 as textures in an elevation plan as shown in FIG. 6.

Compass 622 allows a user to orient an elevation according to a direction measured by compass 622.

Circle drawing element 624 allows a user to draw circles of various sizes conveniently. A user can drag circle drawing element 624 and change the radius of the circle to suit the user's desire.

Square drawing element 626 allows a user to draw squares of various sizes. Square drawing element 626 provides a way for the user to select a size of square to suit the user's desire.

Octagon drawing element 628 allows a user to draw octagons of various sizes. A user can use octagon drawing element 628 to change the size and position of an octagon shape to be added to the canvas to suit the user's desire.

Triangle drawing element 630 allows a user to draw triangles of various sizes. A user can use polygon drawing element 628 to change the size and position of a triangle shape to be added to the canvas to suit the user's desire.

Image deletion button 632 initiates the removal of a texture from the canvas per the direction of the user.

Image addition button 634 initiates the addition of a texture to the canvas per the direction of the user.

Device menu expansion button 636 allows a user to expand a menu of device parameters a user can select, e.g., brightness of the display.

FIG. 7A illustrates a floor plan created by an exemplary user in accordance with embodiments of the present invention.

JavaScript can be used to draw graphical elements added by a user in FIG. 6 and FIG. 7A. For example, a rectangle can be drawn in black color 20 pixels by 40 pixels:
var example=document.getElementById(‘example’);
var context=example.getContext(‘2d’);
context.fillStyle=‘black’;
context.fillRect(20, 20, 40, 40);

More complicated shapes can be constructed in a like manner combining simpler shapes. The above shape metadata is used to draw a shape along a defined path, or outline. This can be done using the JSON ‘path’ property, where paths are an array of path segments. A Path segment is a section of an overall shape. For example, it can be line and curve segments. To define the type of segment, there can be defined an ‘order’ which is specified as a number. An order of 1 corresponds to a linear segment, and higher orders can used to introduce cubic and quadratic curves, for example. Once the user has specified the type of path segment the user desires, there must be defined an array of points used to draw the segment. User additions of simple shapes as well as file paths of images can be stored in JavaScript Object Notation (JSON). An image can be directly encoded in JSON, but a large amount of data would be required for encoding.

As the user manipulates the UI shown in FIG. 6 and FIG. 7A, the collection of shapes, text, and images are stored in JSON and represented by coloring pixels on a screen or printer according to the layers in the image. In embodiments, layers are the different levels at which one can place an object or image file. Layers can represent a part of a picture, either as pixels or as modification instructions. Layers can be stacked on top of each other, and depending on the order, determine the appearance of the final picture. Layers can be stacked, merged, or defined when creating a digital image. Layers can be partially obscured allowing portions of images within a layer to be hidden or shown in a translucent manner within another image. Layers can also be used to combine two or more images into a single digital image.

JSON object format is often used in embodiments to store Site Drawings. JSON object format can be conveniently used to store Site Drawings in a database or to transmit data on a server. Many programming languages provide implementations for JSON. Popular languages such as PHP, Python, C #, C++, and Java provide good support for the JSON data interchange format. Popular programming languages commonly used in the art rely on JSON and its implementation for data transfer, and thus have provide good support for JSON. Therefore, the present disclosure allows for Site Drawings to be processed and utilized with ease in a wide variety of different web applications and within and among organizational (i.e., corporate) networks.

Drawing 701 is a floor plan constructed using the functionality described above. One shape may completely cover text for example as represented on a UI depicting Drawing 701, as one shape may be positioned in front of text, obscuring the text from view in the UI. Whereas JSON format can store all layers in an image, pixel by pixel values do not take into account non-visible layers. This is another advantage of working the present invention because the techniques provided by the present disclosure allow for a user to durably store and save information represented in non-visible layers.

Line tool 700 allows a user to draw along a linear path. Pixels to be colored are restricted to those that bear a linear relation stemming from an origin selected by a user.

Freehand tool 702 allows a user to color in any pixels on the canvas. Although freehand tool 702 provides maximum flexibility, it is more difficult to operate especially for inexperienced users.

Info tool 704 allows a user to add information such as operating and service instructions to the floor plan. The information could be stored locally on the user's device or retrieved from an external database.

Openings menu 706 provides a user a range of possible openings to depict through which it is useful for telecommunications lines to travel. Various shapes and sizes can be made available to best depict the conditions in a particular building.

Label menu 708 provides a user with prepopulated text fields to quickly and conveniently position on the display rather than the user having to type the labels individually. For example, a user can find the label for the name of a particular piece of telecommunications equipment.

Components menu 710 provides a user a range of possible telecommunications equipment to depict in Drawing 701. When the user clicks on the Components menu 710, different telecommunications equipment options are selectable to be drawn. For example, a drop-down menu may be displayed including a list of selected equipment. Examples of telecommunications equipment which could be listed include antennas, switches, telecom towers, fiber-optic cables, antennas and routers. Quantitative and qualitative representations can be made. Selecting the Components menu 710 may also provide a screen (such as a popup window as shown in FIG. 7B) through which the selected telecom equipment's parameters and properties may be displayed and/or input. Based on the user input parameters, the telecommunications equipment size and direction can be changed. For example, by changing a height or an azimuth of the antenna in FIG. 7B, the change will be reflected in the drawn antenna. A user can create scale models in which the lengths and sizes of components like cables are specified by a user and shown on the user interface of FIG. 7A.

Several aspects of the user interface of FIG. 6 are also depicted in FIG. 7A. Left status indicator bar 600 displays parameters related to the operating conditions of the device. Right status indicator bar 601 displays parameters related to the operating conditions of the device and its communications network service. More and/or different indicators could be displayed at other times or in other embodiments. Command button 602 triggers one or more preset options to be presented to a user. Done button 604 allows a user to save the elevation and exit the user interface view.

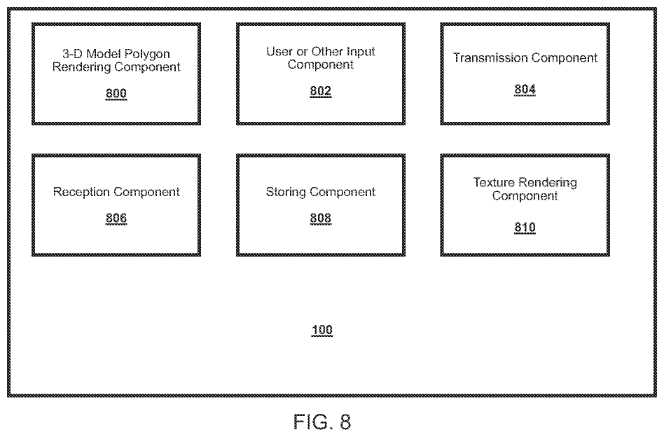

FIG. 8 illustrates arithmetic and logic units within a device, such as device 100 illustrated in FIG. 1 containing processor 104, configured for an example embodiment.

3-D model polygon rendering component 800 uses polygonal modeling to depict 3D objects on a user interface using smaller component polygons. Each polygon is a flat shape that is defined by the position of its vertices (or points) and its connecting edges. The surfaces of the polygons can be covered by textures and complicated models of any shape can be built completely out of polygons. If a user requires more smoother looking surface and more details, etc.), the user can increase the number of polygons used to represent the 3-D object. This will increase the computing power required by 3-D model polygon rendering component 800.

User or other input component 802 receives input from a user to select a texture to be applied to the polygons of the 3-D model. Input could be received for example at a keyboard or a cursor control apparatus as user or other input component 802 may include one or more components that permit a device (e.g., device 100) to receive information, such as via user input (e.g., a touch screen, a keyboard, a keypad, a mouse, a stylus, a button, a switch, a microphone, a camera, and the like). User or other input component 802 can include a camera for capturing an image or a non-transitory computer-readable storage medium containing a stored image.

Images to be used as textures can be retrieved from an internet source via transmission component 804 and reception component 806. Transmission component 804 is configured to transmit communications (e.g., wired, wireless) to another apparatus. Transmission component 804 may perform signal processing on the generated communications, and may transmit the processed signals. In some embodiments, the transmission component 804 may include one or more antennas, a transmit processor, a controller/processor, a memory, or a combination thereof. In some embodiments, the transmission component 804 may be co-located with the reception component 806 such as in a transceiver and/or a transceiver component. Reception component 806 is configured to receive communications (e.g., wired, wireless) from another apparatus. Reception component 806 may receive communications, such as control information, data communications, or a combination thereof, from another apparatus. Reception component 806 may provide received communications to one or more other components such as storing component 808 and/or texture rendering component 810. In some aspects, the reception component 806 may perform signal processing on the received communications, and may provide the processed signals to the one or more other components. In some embodiments, the reception component 806 may include one or more antennas, a receive processor, a controller/processor, a memory, or a combination thereof.

Storing component 808 may be configured to or may comprise means for storing textures to be used by texture rendering component 810. For example, textures can be stored in a database according to preset parameters. Storing component 808 may store textures in working memory, in a storage location local to a device or storage may occur in some external database, external server, or web application.

Texture rendering component 810 may be configured to or may comprise means to render a model of a building with textures applied to surfaces in the model. The number of dimensions depicted in the model is variable. In a two-dimensional context texture rendering component 810 could render an elevation depicting surfaces such as walls with textures applied to the walls from images stored in storing component 808. If a three-dimensional model is desired, texture rendering component 810 can apply textures to the surfaces of the polygons generated by 3-D model polygon rendering component 800.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method of providing a site drawing, the method including:
displaying, on a display of a device, a user interface configured for one or more of creating, accessing, and editing Site Details for a Site;
receiving a selection from a user for one from among an elevation and a floor plan;
displaying a canvas on the user interface;
receiving one or more inputs from the user corresponding to the addition of one or more components to the canvas at one or more coordinates; and
storing the one or more components and their coordinates in JavaScript Object Notation (JSON).

2. The method according to claim 1, wherein the one or more inputs corresponding to the addition of one or more components at one or more coordinates are received by:
establishing a network communications linkage with a server;
sending an indicator of a geographic location; and
receiving an image corresponding to the geographic location.

3. The method according to claim 1, wherein the receiving the one or more inputs comprises:
receiving a first input for selecting a component type from among a plurality of predetermined telecommunications equipment components;
based on the received first input, displaying a window through which parameters of a component corresponding to the selected component type are provided;
receiving a second input to adjust at least one parameter displayed in the window; and
drawing the component on the canvas based on the adjusted at least one parameter.

4. The method according to claim 1, wherein the one or more inputs corresponding to the addition of one or more components at one or more coordinates create a three-dimensional representation.

5. The method according to claim 4, further comprising:
receiving a selection from the user of a surface in the three-dimensional representation;
applying a texture to the selected surface according to an input received from the user; and
displaying on the user interface the texture on the selected surface of the three-dimensional representation.

6. The method according to claim 1, further comprising transmitting the one or more components and their coordinates in JavaScript Object Notation (JSON) over a communications network to a server.

7. The method according to claim 1, further comprising transmitting a bitmap of the one or more components over a communications network to a server.

8. The method according to claim 1, further comprising:
receiving, at a second device, the one or more components and their coordinates in JavaScript Object Notation (JSON);
parsing the received JSON;
calculating a rendering scaling factor based on parameters of the second device; and
displaying the one or more components on a user interface of the second device according to the rendering scaling factor.

9. An apparatus comprising:
a memory storage storing computer-executable instructions; and
a processor communicatively coupled to the memory storage, wherein the processor is configured to execute the computer-executable instructions and cause the apparatus to:
display a user interface configured for one or more of creating, accessing, and editing Site Details for a Site;
receive a selection from a user for one from among an elevation and a floor plan;
display a canvas on the user interface;
receive one or more inputs from the user corresponding to the addition of one or more components to the canvas at one or more coordinates; and
store the one or more components and their coordinates in JavaScript Object Notation (JSON).

10. The system according to claim 9, further comprising a network connection interface configured to transmit data over a computer communications network to a server.

11. The system according to claim 9, further comprising a second device configured to:
receive the one or more components and their coordinates in JavaScript Object Notation (JSON);
parse the received JSON;
calculate a rendering scaling factor based on parameters of the second device; and
display the one or more components on a user interface of the second device according to the rendering scaling factor.

12. The system according to claim 9, further comprising an optical device for capturing an image.

13. A non-transitory computer-readable medium containing instructions, which when executed by one or more processors cause an apparatus to:
provide a user interface to a user configured for one or more of creating, accessing, and editing Site Details for a Site;
receive a selection from a user for one from among an elevation and a floor plan;
display a canvas on the user interface;
receive one or more inputs from the user corresponding to the addition of one or more components to the canvas at one or more coordinates; and
store the one or more components and their coordinates in JavaScript Object Notation (JSON).

14. The non-transitory computer-readable medium according to claim 13, wherein the instructions further cause the apparatus to:
receive a selection from the user of a surface in the three-dimensional representation;
apply a texture to the selected surface according to an input received from the user; and
display on the user interface the texture on the selected surface of the three-dimensional representation.

15. The non-transitory computer-readable medium according to claim 13, wherein the instructions further cause the apparatus to:
establish a network communications connection with a server;
send an indicator of a geographic location; and
receive an image corresponding to the geographic location.

16. The non-transitory computer-readable medium according to claim 13, wherein the instructions cause the apparatus to create a three-dimensional representation of the one or more components at one or more coordinates.

17. The non-transitory computer-readable medium according to claim 13, wherein the instructions cause the apparatus to transmit the one or more components and their coordinates stored in JavaScript Object Notation (JSON) over a computer communications network to a server.

18. The non-transitory computer-readable medium according to claim 13, wherein the instructions cause the apparatus to transmit an output image bitmap of the one or more components over a computer communications network to a server.
